(19) United States
(12) Patent Application Publication
(10) Pub. No.: US 2024/0383806 A1
(43) Pub. Date: Nov. 21, 2024

(54) METHOD FOR THE STABILIZATION OF MARINE CLAYS

(71) Applicants: POLITECNICO DI BARI, Bari (IT); ETH ZURICH INSTITUTE OF GEOTECHNICAL ENGINEERING, Zurich (CH)

(72) Inventors: Alexander Puzrin, Zurich (CH); Claudia Vitone, Bari (IT); Rossella Petti, Foggia (IT); Michael Plötze, Zurich (CH); Maurizio Iler Marchi, Milano (IT)

(21) Appl. No.: 18/696,524

(22) PCT Filed: Sep. 29, 2022
(86) PCT No.: PCT/IB2022/059288

§ 371 Date: Mar. 28, 2024

(30) Foreign Application Priority Data
Sep. 30, 2021 (IT) 102021000025103

(51) Int. Cl. C04B 14/28; C04B 14/10; C04B 20/02; C04B 20/04; C04B 28/04; C04B 40/00; C04B 111/00; C04B 111/74

(52) U.S. Cl. CPC C04B 14/28; C04B 14/10; C04B 20/026; C04B 20/04; C04B 28/04; C04B 40/0046; C04B 2111/0075; C04B 2111/74

(57) ABSTRACT

The present invention relates to a new method for stabilising marine clays such as sediments, marine sediments, or dredging muds by using mussel shell powder and cement, their use and a respective product. A properly treated milled shell powder is mixed with a cement in order to obtain a solid composition of powders, which is subsequently mixed with the marine clay to obtain a product that can be used in the building industry.

### TECHNICAL FIELD

The present invention relates to a novel method for stabilising marine clays such as sediments, marine sediments or dredging muds.

### PRESENT STATUS OF THE ART

It is known that a big quantity of shells of mussels is transferred every day to rubbish dumps in Italy and in Europe in order for them to undergo expensive disposal procedures. They represent almost 10% of the total production of world fisheries and 14% of the total value of aquaculture production.

Just to mention Taranto, which accommodates one of the largest mussel farmers in the world, approximately 12 tonnes of waste per day are estimated to be transferred to rubbish dumps, some of which tonnes are presently disposed illegally.

“Marine clays” are natural deposits that are commonly located in coastal areas which, as defined in the present text, feature a negative consistency index, that is to say they are “soft”. They feature a granulometric composition that is typical of fine-grained soils, i.e. at least 50% of the particles have an equivalent diameter less than 65 microns.

Soft marine clays include, amongst others, dredging muds, sediments, and marine sediments, which are neoformation marine clays, usually featuring very low consistencies, high water content, and an abundant presence of organic substances.

It is known that in Europe, every year, 100 to 200 million m³ of sediments are dredged. In Italy, every year, there are 50 million m³ of sediments to dredged, with an annual increase of 5 million m³. Also, dredged material management is expensive and complex.

Sediments are the product of alteration and degradation of rocks and undergo dissolution and transportation phenomena by air and run-off waters or ice and subsequent deposit and accumulation. Also, dredging muds are a mixture of water and silt or clay material, with a consistency ranging from semifluid to plastic. Even when not polluted by anthropic actions, sediments and dredging muds represent well-known high complexity geomaterials because of their variable contents of organic materials, carbonates (for example, fossils and seashells) and diatoms, because of their low strengths and high deformability. Consequently, their re-use shall necessarily pass through mechanical and/or chemo-mechanical treatment systems in the case of polluted sediments.

No European directives exist at present that specifically deal with a complete and uniform sediment management; however, Directive 2008/98/CE addresses alternative management options to the disposal of sediment as waste. The National regulations reflect the basic principles of the Waste Framework Directive, which give priority to re-use, recycling, and recovery of sediments without endangering human's health and damaging the environment. In Italy, the Ministerial Decree DM 173 of 2016 clearly opted for recognizing sediments as resources to be exploited rather than a waste to be disposed of.

However, in most cases sediments are still managed as a “waste” and the most used practice is their disposal in sediment tanks, with high environmental risks associated therewith. This is also due to the circumstance that, as said before, sediments, because of their physical-mechanical as well as chemical statuses, often require complex and (energetically and/or economically) expensive treatments in order to improve their performances and make their re-use possible. One of the most used solutions consists of stabilising such materials by way of traditional, hydraulic binders, the production of which, as known, a release of big quantities of CO₂ in the atmosphere is associated with.

In order to reduce the environmental impact in this sector, the development and use of green binders in civil engineering applications have been progressively the object of studies and researches in the last years.

More recent researches propose the use of natural additions such as aggregates in cement mortars or as a partial replacement of traditional binders in preparing concretes. Amongst these, seashells have been the object of experiments both as additives of cement and as a substitute of inert materials in cement mortars and in concrete.

Shell treatment includes a washing step aiming at removing contaminants, organic materials, and ions such as chloride (Martinez-Garcia, C., González-Fonteboa, B., Martínez-Abella, F., López, D.C. (2017). Virtual special issue bio-based building materials. Performance of mussel shell as aggregate in plain concrete. Constr Build Mater 139:570-583. https://doi.org/10.1016/j.conbuildmat.2016.02.091), crushing, milling, sieving (the sizes proposed in the literature range from 5 mm to 63 mm) and, finally, a thermal treatment. Calcium oxide (CaO), which is an essential component for enhancing concrete strength (Lertwattanaruk, P., Makul, N., & Siripattarapravat, C. (2012) Utilization of ground waste seashells in cement mortars for masonry and plastering. Journal of Environmental Management, 111, 133-141. https://doi.org/10.1016/j), can be produced starting from shells by calcining them, i.e. submitting them to a high temperature treatment (from 500 to 1000° C. ca), in order to foster conversion of CaCO₃ into carbon and calcium oxide (CaO) (Olivia, M., & Oktaviani, R. (2017). Properties of concrete containing ground waste cockle and clam seashells. Procedia Engineering, 171, 658-663. https://doi.org/10.1016/j.proeng.2017.01.404).

The thermal shell treatment process is often cited and its temperature varies as a function of the crystallinity and amorphism level to be achieved, as well as of the nature of the products that are formed through the volatility of organic impurities and saline substances. Specifically, the thermal treatments proposed in the cited documents relate to temperatures ranging from 115° C. ca. for 24 h to 1000° C. ca. for 1 h. The thermal treatment essentially depends on the role to be played by shells in preparing the final product: higher treatment temperatures (calcination) are necessary if shells are used to partially replace a traditional binder in preparing concretes; conversely, temperatures below 120° C. ca. are sufficient if shells are used as an inert material.

Some authors (e.g., Bamigboye, G. O., Nworgu, A. T., Odetoyan, A. O., Kareem, M., Enabulele, D. O., Daniel, E., & Bassey, D. E. (2021). Sustainable use of seashells as binder in concrete production: Prospect and challenges. Journal of Building Engineering, 34, 101864. https://doi.org/10.1016/j.jobe.2020.101864) verified the possibility of re-using shells as a substitute of traditional limestone in cement production. On the other hand, other studies focused on the use of shells as a substitute of rough and/or fine aggregate in concrete production (e.g. Chandra, K., Behera, S., & Jena, S. (2020). Effect of rice husk ash on mechanical properties of concrete containing crushed seashell as fine aggregate. Materials Today: Proceedings, 32, 838-843. https://doi.org/10.1016/j.matpr2020.04.049). The percentages typically considered when seashell powder replaces cement range from 5 to 20% by weight, with optimum ratios of 5% in order to cater for appropriate mechanical characteristics.

All this literature mainly relates to seashells and in some cases only it is spoken about mussel shells which, as known, have a similar composition, both being mainly formed of silica oxide and calcium oxide.

All in all, mortars produced by using mussel shell powder feature a more compact microstructure, a better cement setting, and a better mortar strength, thus allowing to reduce the cement content in the final composition of the mortar and to reduce production costs. However, mortar strength can only be improved by calcining the shells and consequently the energy cost of the thermal treatment that the shells are submitted to before being re-used remains high. In few cases of treatments at lower temperatures (120° C. ca.), replacement percentages have been tested up to 20-25% and to 12.5% of sand and/or gravel for structural and non-structural concretes.

The present status of the art also includes contributes related to soil stabilisation with innovative solutions which make use of natural additions and/or traditional binders. Amongst these, let's cite the addition of oyster shells calcined at 1000° C. to Portland cement and lateritic soil sands (e.g., Ayininuola, G. M., Afolayan, O. D. (2018). Potential of Oyster Shell Ash Activated with Cement as soil Stabilizer for Road Construction. International Journal of Engineering and Advanced Technology (IJEAT) ISSN: 2249-8958, Volume-7 Issue-5, June 2018).

With reference to mechanical stabilisation of sediments and dredging muds, the documents known in the present status of the art make reference to mechanical treatments based on traditional hydraulic binders (Federico, A., Vitone, C., Murianni, A. (2015). On the mechanical behaviour of dredged submarine clayey sediments stabilised with lime or cement. Canadian Geotechnical Journal 52:2030-2040) or mention is made of the addition of the following elements as innovative cementitious binders:
super-absorbing biopolymers introduced in the cement mixing method as a water reduction agent in order to improve the strength properties of the cemented sediment at very high water contents;
bacteria;
combinations of hemi-hydrated phosphor-gypsum, sodium metasilicate, and pozzolanic waste materials, such as blast furnace slags.

The documents of the present status of the art are apparently limited in that they do not use mussel shells for re-use of sediments or dredging muds. Also, they do not report any possibility of treating sediments or muds with mixtures of hydraulic binders and mussel shell powders. Also, in the present status of the art, shells are generally treated by bringing them to calcination with a greater energy consumption and, when treated at lower temperatures, they operate as inert materials in mortars or in concretes. Finally, they are used as additions for improving setting and workability of binders, not in an even partial replacement of cement.

Therefore, a need is strongly felt about for providing products for industrial use that, as compared to those making use of traditional cements, are capable not only of exploiting the necessary functional characteristics, but also minimizing the environmental impact resulting from their use.

### OBJECTS AND SUMMARY OF THE INVENTION

The object of the present invention is to overcome the drawbacks of the present status of the art. Specifically, an object of the present invention is to provide a method for stabilising marine clays, such as sediments, marine sediments, or dredging muds, by using mussel shell powder and cement. A second object of the present invention is to provide a marine clay, sediments, marine sediments or dredging muds, mussel shell powder and cement based product.

The product obtained in the present invention is a product obtained from re-using two types of waste, easy to find and difficult to dispose of, together with cement: the former waste relates to marine clays, such as sediments, marine sediments or dredging muds, and the second waste relates to mussel shells characterized by such mechanical properties as to render it suitable for a variety of industrial applications.

Since the product according to this invention is formed of as much as two types of waste easy to find, it can be defined as a low environmental impact one.

A further object of the present invention is that of using the product thus obtained directly in situ for preparing road subgrades or for manufacturing a prefabricated product ex-situ, such as an outdoor self-locking eco-block, an artificial breakwater (tetrapod or antifer or other), or a quay construction boulder.

These objects of the present invention and others are achieved by using a method for treating marine clays comprising the following steps:
a. heating mussel shells to a temperature below the calcination temperature;
b. milling the heated mussel shells up to obtaining a powder having an appropriate particles size distribution;
c. mixing the milled shell powder obtained in step b) with a cement, in a proportion ranging from 5% to 50% by weight as referred to the total weight of cement plus powder, in order to obtain a solid composition of powders;
d. obtaining a final product by mixing the solid composition of powders obtained in step c) with marine clays characterised by a negative consistency index, wherein said solid composition of powders is present in a percentage ranging from 2% to 20% by weight as referred to the weight of the final product.

Step a) of the method according to the present invention comprises a thermal treatment aiming at eliminating most organic substances that are possibly present in the outer part of the shell itself. Such thermal treatment is characterized in that it takes place well below the calcination temperature (500° C.). Advantageously this treatment is performed at a temperature ranging from 90° C. to 140° C., preferably at 105° C., for a duration time ranging from 12 to 50 hours, preferably 48 hours. A person skilled in this sector might easily vary this duration time as a function of the temperature selected for thermal treatment.

In a preferred aspect of this invention, mussel shells are washed by running water for approximately ten minutes before undergoing the described thermal treatment. The water used for this purpose is either at the ambient temperature or is preferably hot water (from 30° C. to 60° C.). As stated before, marine clay is a term that comprises different types of materials. According to the present invention, use is advantageously made of a marine clay selected from a sediment, a marine sediment, or a dredging mud, but it might even be a river or lake sediment.

The marine clay of the method according to the invention is characterized in having a negative consistency index, i.e. CI<0.

The consistency index (CI) is an index that defines material consistency. In order to assess the type of behaviour of a soil and its consistency status, it is necessary to consider its water content and compare it to the values corresponding to the liquid limit (w_{L}) and to the plastic limit (w_{P}). The liquid limit and the plastic limit are known in geotechnics as the Atterberg limits, and they indicate the limit value of the water content whereby a transition of the physical status of a sediment takes place.

This comparison is necessary because, water content being equal, not all soils have the same behaviour, which means that different soils will have different liquid and plastic limit values. w_{L} and w_{P} limit values are determined according to standard procedures (ASTM D4318, 2010).

Having calculated w_{L} and w_{P}, the plasticity index (PI) is calculated on the basis of their difference:

$$P I = {w}_{L} - {w}_{P} \qquad ( 1 )$$

which just represents the range of water content values internally to which a soil is in the plastic status. At this point, the consistency index (IC) can be calculated by using the following formula (2)

$$C I = ( {w}_{L} - w ) / PI \qquad ( 2 )$$

where w is the water content.

In a preferred aspect of this invention, the particles size distribution of the marine clay is such that at least 50% of the particles have a diameter less than 75 μm.

Even though any kinds of mussel shells can be used in the present invention, in a particularly preferred aspect shells of mussels of the Mytilus galloprovincialis type, i.e., a waste that is easy to find and difficult to dispose of in the mussel culture industry, are used.

The mussel shells according to step b) of the method of the invention are ground to a particle size of less than 300 microns, preferably to a particle size of between 60 μm and 100 μm.

In a preferred aspect of the invention, the mussel shell powder is sieved to a particle size characterised by D₅₀=6.32 μm and Cᵤ=2.213. D₅₀ is the diameter corresponding to 50% of passing, whereas Cᵤ is a coefficient that assesses the uniformity of a sample in terms of grain size distribution, and it is defined by the following formula (3):

$${C}_{u} = {D}_{60} / {D}_{10} \qquad ( 3 )$$

where D₆₀ is the diameter corresponding to 60% of passing and D₁₀ is the diameter corresponding to 10% of passing.

After obtaining the mussel shell powder milled according to step b), this one is mixed with a cement.

In a preferred aspect of this invention, reference is made to a cement as described in the UNI EN 197-1(2011) standard.

All cements described in said standard can be conveniently used in the process of the present invention, whereas the type I cements (Portland cement) and the type III ones (slag cement) are particularly preferred. The powder obtained from the milled shells is mixed with the cement according to the UNI EN 197-1 standard in a proportion from 15% to 50% by weight as referred to the total powder and cement in order to obtain a solid composition of powder.

In the last step of the process, the solid composition of powders obtained in step c) is mixed with marine clays characterized by a negative consistency index, wherein said solid composition is present in a percentage from 2% to 20% by weight as referred to the final product. Preferably the composition according to step c) ranges from 8% to 16% by weight as referred to the final product. A second object of the present invention is a product obtained according to the method described in steps a) thru d) as above.

A further object of the present invention is the use of the product obtained according to the method described in steps a) thru d) as described above directly in situ for preparing a road sub-grade or for manufacturing ex-situ a prefabricated product such as, for example, an outdoor self-locking eco-block, an artificial breakwater (tetrapod or antifer or other), or a boulder for the construction of a quay.

Further characteristics and objects of the present invention will be more apparent from the following description.

Unless otherwise specified, all terms of the art, notations, and other scientific terms here used are meant to have the meanings commonly understood by those who are skilled in the technique that this description refers to. In some cases, terms with commonly understood meanings are here defined for the sake of clearness and/or for a prompt reference; consequently, the insertion of such definitions in the present description shall not be interpreted as being representative of a substantial difference from that which is a generally understood in the art. The terms “comprising”, “having”, “including” and “containing” are to be considered as open terms (i.e., the meaning “comprising, but not limited to”) and are to be also considered as a support for terms like “to basically consist of”, “basically consisting of”, “to consist of” or “consisting of”. The use of “for example”, “etc.”, “or” indicates non-exclusive alternatives without any limitations, unless otherwise specified. The use of “includes” means “include”, but is not limited to” unless otherwise specified.

### BRIEF DESCRIPTION OF THE FIGURES

The invention will be described here below with reference to a number of examples which are provided for exemplary, non-limitative purposes as illustrated in the attached figure.

FIG. 1 summarily describes the steps of the method according to the present invention.

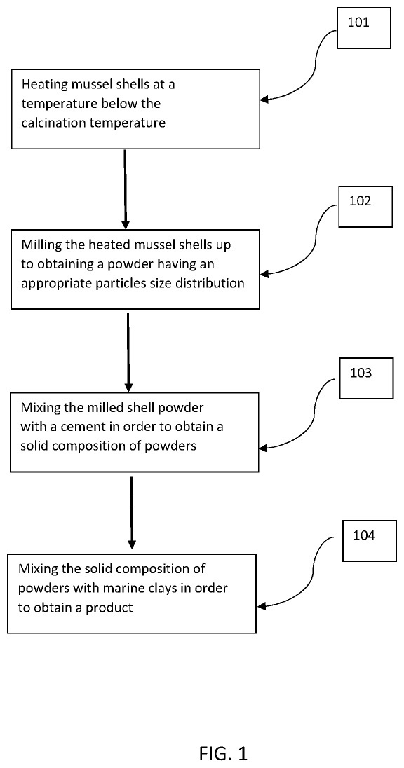

### DETAILED DESCRIPTION OF THE INVENTION

Whereas the invention is susceptible of various alternative modifications, some preferred embodiments will be described below in details. However, it is understood that there is no intention of limiting the invention to the specific embodiment here illustrated, but, on the contrary, the invention is meant to cover all modifications and equivalents that fall within the scope of the invention as set forth in the claims. The individual steps of the process are indicated in the process flowchart illustrated in FIG. 1.

In the process flowchart of FIG. 1, mussel shells are treated at a temperature lower than the calcination one, in order to eliminate most organic substances that might be present in the shells 101.

At the end of the thermal treatment, the heated mussel shells are milled up to obtaining a powder having an appropriate particles size distribution 102.

The powder obtained from the properly milled shells is mixed with a cement, preferably according to the UNI EN 197-1 (2011) standard in a proportion ranging from 15% to 50% by weight as referred to the total weight of the cement and of the powder in order to obtain a solid composition of powders 103.

Finally, the solid composition of powders is mixed with marine clays characterized by a negative consistency index CI<0, wherein said solid composition is present in a proportion from 2% to 20% by weight as referred to the total weight of the final product 104.

The present invention features numerous particularly important advantages.

First of all, the thermal treatment 101 is performed at temperatures well below than the calcination one (500° C.), namely from 90° C. to 140° C., preferably 105° C., because advantage is taken from the chemical activation potentials deriving from the addition of marine clays in which the fine fraction is predominant.

Secondly, it is not necessary to add water to obtain the final product in the marine clays-cement mixing step because use is made of sea water already present in the sediments. The final product is easy to obtain because the sediments are used in their natural state in terms of content of water and salts in the interstitial fluid and natural organic substance.

In this regard, here follows a calculation of the water content (w) of the natural sediment obtained by weighing before and after drying:

$$w ( \% ) = ( [ humid sample weight ( gr ) - dry sample weight ( gr ) ] ) / ( dry sample weight ( gr ) ) \times 100 ( w sediment = 74 \% )$$

This water content has been subsequently used to calculate the addition of binder, as described in the examples below.

The following Table 1 shows the main physical-chemical characteristics of the sea water used in the present invention:

TABLE 1

| | Conductivity | Salinity | Chlorides | Sulphates |
|---|---|---|---|---|
| PH | (μS/cm) | (ppt) | (mg/l) | (mg/l) |
| 9.21 | 50.4 | 33.17 | 6750 | 2810 |

Concerning the mineralogic characterisation of the sediment used in the present invention. this one is shown in Table 2 below.

TABLE 2

| | Sediment | |
|---|---|---|
| Mineral | (% by mass) | error |
| Quartz | 17.4 | 0.3 |
| Microcline | 2.0 | 0.2 |
| Orthoclase | 2.0 | 0.3 |
| K-Feldspar group | 4.0 | 0.5 |
| Albite | 6.2 | 0.3 |
| Plagioclase group | 6.2 | 0.3 |
| Calcite | 23.8 | 0.6 |
| Aragonite | 3.1 | 0.2 |
| Dolomite/Ankerite | 3.1 | 0.2 |
| Alite | 2.2 | 0.1 |
| Pyrite | 1.1 | 0.1 |
| Rutile | 0.4 | 0.1 |
| Anatase | 0.6 | 0.1 |
| Amorphous | 12.7 | 1.2 |
| Tot. Non-clay | 74.7 | |
| Kaolinite | 3.6 | 0.5 |
| Kaolinite group | 3.6 | 0.5 |
| Muscovite 2M1 | 7.8 | 0.3 |
| Mica (bi-octahedral) | 7.6 | 0.3 |
| Smectite (bi-octahedral) | 10.1 | 1.5 |
| Chloride (tri-octahedral | 4.0 | 0.3 |
| Tot. Clay/phyllosilicate | 25.3 | |
| Tot. identified | 100.0 | |

Concerning the treatment of mussel shells, these ones have been taken from mussel farmers in Taranto and have been submitted to a cleaning and milling treatment.

In particular, 1 kg of mussel shells have been washed in hot water (40° C. for 10 minutes). Then they have been put in an aluminium tray and inserted into an oven in order to submit them to a thermal treatment at 105° C. for 48 hours.

At the end of the thermal treatment, they have been taken off from the oven and milled in a Retsch crusher for 15 minutes. They have subsequently been sieved thus obtaining a particles size distribution characterised by D₅₀=6.32 mm and Cu=2.213, where:
D₅₀ is the diameter corresponding to 50% of passing and Cu is a coefficient that assesses the uniformity of a sample in terms of grain size distribution and is defined as: Cu=D₆₀/D₁₀, where D₆₀ is the diameter corresponding to 60% of passing and D₁₀ is the diameter corresponding to 10% of passing.

In all examples described below, the cements used are cements according to the EN 197.1 (2011) standard marketed by Italcementi®.

A particularly significant aspect is in that the marine clays mixed with mussel shell powder present a synergetic effect in the presence of cement.

The cement mixed with mussel shell powder only presents a remarkable decrement of mechanical strengths as referred to cement as such, and the cement mixed with the solid mussel shell powder/marine clay composition behaves better in terms of mechanical strengths as compared to the cement only mixed with marine clays only.

### EXAMPLE 1 (REFERENCE) TESTS IN STANDARD MORTAR

Mussel shells treated as described above have been used in replacement of Portland cement for producing standard mortars (25% by weight as referred to the total weight of the components). The standard mortar has been prepared according to the indications on composition, sample preparation, and curing, as set forth in the UNI EN196-1, 2016 standard.

The results of the mechanical tests have been compared to those of the Portland cement (CEM I) used as a standard, as detailed in tables 3 and 4 below.

TABLE 3
Standard mortar with CEM I

| | Weight | Rc A | Rc B | Rc Average | Rf |
|---|---|---|---|---|---|
| Seasoning | (g) | (MPa) | (MPa) | (MPa) | (MPa) |
| 7 days | 577.70 | 55.39 | 55.91 | 55.65 | 10.06 |
| 28 days | 578.30 | 64.65 | 64.45 | 64.55 | 9.10 |

where Rc stands for compressive strength and Rf stands for flexural strength.

TABLE 4
Standard mortar with CEM I and mussel shell flour (25%)

| | Weight | Rc A | Rc B | Rc Average | Rf |
|---|---|---|---|---|---|
| Seasoning | (g) | (MPa) | (MPa) | (MPa) | (MPa) |
| 7 days | 495.80 | 25.50 | 26.88 | 26.19 | 4.62 |
| 28 days | 500.70 | 27.18 | 27.87 | 27.52 | 4.73 |

As it can be noted from a comparison between the data relevant to Tables 3 and 4, the addition of mussel shell powder to CEM I drastically reduces the mechanical strength of the standard mortar.

### EXAMPLE 2 (INVENTION)

Stabilisation of marine clay in the form a marine sediment with a quantity of binder equal to 8% as compared to the sediment. By binder we mean a solid cement (6%) and mussel shell powder (2%) composition.

Approximately 1 kg (=Pₜₒₜ) of marine sediment coming from a fill-in basin in the port of Taranto has been taken and mixed in its natural status (water content, w, equal to 74% measured as described above in the description) in a mechanical mixer for 10 minutes at a speed of 285 RPM.

The mussel shell powder has been prepared as described above in the description.

A quantity corresponding to 2% as referred to the weight of the dry sediment has been weighed.

In details:

$$Weight calculation ( dry ) Ps = {P}_{t o t} / ( 1 + w ) = 1 \; 000 / ( 1 + 0.74 ) = 574.7 g$$

$$Quantity of mussel shell powder = {P}_{s} * 2 / 100 = 11.49 g$$

A quantity corresponding to 6% of Portland cement 52.5 R type I has been weighed, the percentage having been calculated as referred to the weight of the dry sediment (Pₛ).

In details:

$$Weight calculation ( dry ) {P}_{s} = {P}_{tot} / ( 1 + w ) = 1 \; 000 / ( 1 + 0.74 ) = 574.7 g$$

$$Quantity of cement = {P}_{s} * 6 / 100 = 34.48 g$$

The two powders, cement and shell, have been joined, first between each other and subsequently mixed with the sediment. Thus, the material has been mixed for 5 minutes at a speed of 140 RPM. The same procedure has been repeated for comparison purposes, by using the Portland cement 52.5 R type I at 8% by weight as referred to the sediment.

The results of the product, in terms of mechanical strengths after 28 days of curing, are shown in Table 5.

IC is the consistency index, an index that assesses the consistency of a product calculated as described in the text, and R_Cu (kPa) is the undrained shear strength, i.e. the maximum tangential tension that can be applied to the soil before a breakage occurs in terms of total tensions.

TABLE 5

| Geo-stabilised product | CI | R C_{U} (kPa) |
|---|---|---|
| CEM I 52.5R_6% + 2%_mussels | 0.64 | 147.5 |
| CEM I 52.5R_8% (comparison) | 0.59 | 100 |

As it can be noted from the data shown in Table 5, a partial replacement of CEM I with a mussel shell powder increments the value for the consistency index, CI, as well as the undrained shear strength of the mixture, thus resulting in an overall improvement of its mechanical characteristics.

### EXAMPLE 3 (INVENTION)

A marine clay stabilisation has been performed in the form of marine sediment to obtain a product as described in the example 2, but using a cement type III 42.5 N instead of cement type I 52.5R. The results after 28-day of curing are shown in Table 6.

TABLE 6

| Geo-stabilized product | CI | R CU(kPa) |
|---|---|---|
| CEM III 42.5N_6% + 2%_mussels | 0.65 | 173.5 |
| CEM III 42.5N_8% (comparison) | 0.61 | 165.6 |

As it can be noted from the data of Table 6, a partial replacement of CEM III with mussel shell powder increments the value for the consistency index, CI, as well as the undrained shear strength of the mixture, thus resulting in an overall improvement of its mechanical characteristics.

### EXAMPLE 4 (INVENTION)

Marine clay stabilisation in the form of marine sediment with a quantity of binder equal to 16% as reference to the sediment. By binder, we mean a solid cement (12%) and mussel shell powder (4%) composition.

Approximately 1 kg (=Pₜₒₜ) of marine sediment coming from a fill-in basin in port of Taranto has been taken and mixed in its natural status (water content, w, equal to 74% measured as described above) in a mechanical mixer for 10 minutes at a speed of 285 RPM.

The mussel shell powder has been prepared as described above.

A quantity corresponding to 4% by weight as referred to the dry weight of the sediment has been weighed. In details:

$$Weight calculation ( dry ) {P}_{s} = {P}_{t o t} / ( 1 + w ) = 1 \; 000 / ( 1 + 0.74 ) = 574.7 g$$

$$Quantity of mussel shell powder = {P}_{s} * 4 / 100 = 22.99 g$$

A quantity corresponding to 12% of Portland cement 52.5 R type I has been weighed, as a percentage calculated as referred to the dry weight of the sediment (Pₛ).

In details:

$$Weight calculation ( dry ) {P}_{s} = {P}_{t o t} / ( 1 + w ) = 1 \; 000 / ( 1 + 0.74 ) = 574.7 g$$

$$Quantity of cement = {P}_{s} * 12 / 100 = 68.96 g$$

The two powders, cement and shell, have been joined, first between each other and subsequently mixed with the sediment. Thus, the material has been mixed for 5 minutes at a speed of 140 RPM. For comparison purposes, the procedure has been repeated by using Portland cement 52.5 5 R type I at 16% by weight as referred to the sediment.

The results after 28 days of seasoning are shown in Table 7.

TABLE 7

| Geo-stabilised product | CI | R_C_{U}(kPa) |
|---|---|---|
| CEM I 52.5R_12% + 4%_mussels | 1.25 | 557 |
| CEM I 52.5R_16% (comparison) | 1.22 | 511.33 |

The data of Table 7 show that a partial replacement of CEM I with mussel shell powder increments the value for the consistency index, CI, as well as the undrained shear strength of the mixture, thus resulting in an overall improvement of its mechanical characteristics.

### EXAMPLE 5 (INVENTION)

A marine clay stabilisation has been performed in the form of marine sediment to obtain a product as described in example 6, but using a cement type III 42.5 N instead of a cement type I 52.5R. The results after 28 days of curing are shown in Table 8.

TABLE 8

| Geo-stabilized product | CI | R C_{U}(kPa) |
|---|---|---|
| CEM III 42.5N_12% + 4%_mussels | 1.19 | 545 |
| CEM III 42.5N_16% (comparison) | 1.16 | 540.5 |

The data of Table 8 show that the partial replacement of CEM III with mussel shell powder increments the value for the consistency index, CI, as well as the undrained shear strength of the mixture, thus resulting in an overall improvement of its mechanical characteristics.

### EXAMPLE 6 (COMPARISON)

An attempt has been made to stabilise the marine clay with a quantity of powders equally shared between cement and mussel shell powder (50/50).

Approximately 1 kg (=Pₜₒₜ) of marine sediment coming from a fill-in basin in port of Taranto has been taken and mixed in its natural state (water content, w, equal to 74% measured as described above) in a mechanical mixer for 10 minutes at a speed of 285 RPM.

The mussel shell powder has been prepared as described above.

A quantity corresponding to 4% as referred to the dry weight of the sediment has been weighed.

In details:

$$Weight calculation ( dry ) {P}_{s} = {P}_{tot} / ( 1 + w ) = 1 \; 000 / ( 1 + 0.74 ) = 574.7 g$$

$$Quantity of mussel shell powder = {P}_{s} * 4 / 100 = 22.98 g$$

A quantity corresponding to 4% of Portland cement 52.5 R type I has been weighed, as a percentage calculated as referred to the dry weight of the sediment (Pₛ).

In details:

$$Weight calculation ( dry ) {P}_{s} = {P}_{tot} / ( 1 + w ) = 1 \; 000 / ( 1 + 0.74 ) = 574.7 g$$

$$Quantity of cement = {P}_{s} * 4 / 100 = 22.98 g$$

The two powders, cement and shell, have been joined, first between each other and subsequently mixed with the sediment. Thus, the material has been mixed for 5 minutes at a speed of 140 RPM. The results of the product after 28 days of curing are shown in Table 9.

IC is the consistency index, an index that assesses the consistency of a product calculated as described in the text, and R_ Cᵤ (kPa) is the undrained shear strength, i.e. the maximum tangential tension that can be applied to a soil before breakage takes place in terms of total tensions.

TABLE 9

| | CI | R C_{U} (kPa) |
|---|---|---|
| CEM I 52.5R_4% + 4%_mussels | 0.46 | 28.5 |
| CEM I 52.5R_8% (comparison) | 0.59 | 100 |

1. A method for stabilizing marine clays comprising the following steps:
a. heating mussel shells at a temperature ranging from 90° C. to 140° C., below than the mussel shell calcination temperature;
b. milling the heated mussel shells up to obtaining a powder having an appropriate particles size;
c. mixing the milled shell powder obtained in step b) with a cement, said cement being present in a quantity ranging from 15% to 50% by weight as referred to the total weight of cement and powder, in order to obtain a solid composition of powders;
d. obtaining a final product by mixing the solid composition of powders obtained in step c) with marine clays, wherein said marine clays sediments are used in their natural state in terms of content of water and are characterized by a negative consistency index, said consistency index being an index that defines material consistency and being calculated by using the following formula:
CI=(w_{L}−w)/PI
where
w is the water content,
w_{L} the liquid limit, and
PI is the plasticity index, representing the range of water content values internally to which a soil is in the plastic status, said plasticity index being calculated on the basis of the difference between said w_{L} the liquid limit and the plastic limit w_{P},
and wherein said solid composition of powders is present in a percentage from 2% to 20% by weight as referred to the weight of the final product.

2. The method according to claim 1, wherein the marine clays are a sediment, a marine sediment, or a dredging mud.

3. The method according to claim 1 wherein the marine clay has at least 50% of the particles size having a diameter of less than 75 μm.

4. The method according to claim 1, wherein the shells used are of the type Mytilus galloprovincialis.

5. The method according to claim 1, wherein the mussel shells are ground to a particle size of less than 300 μm.

6. The method according to claim 1, wherein the cement according to step c) is selected amongst a type I cement and a type III cement according to the UNI EN 197-1(2011) standard.

7. The method according to claim 1, wherein the solid composition of powders ranges from 8 to 16% by weight as referred to the weight of the final product.

8. A product obtained in accordance with the method according to claim 1.

9. The product of claim 8, wherein the final product is used directly in situ for preparing a road subgrade.

10. The product of claim 8, wherein the final product is used for manufacturing ex-situ a prefabricated product selected from the group consisting of: a self-locking outdoor eco-block, artificial breakwater against wave motion, and a boulder for building a quay.

11. The method of claim 1, wherein the mussel shells are heated at a temperature of 105° C.

12. The method according to claim 5, wherein the mussel shells are ground to a particle size between 60 μm and 100 μm.
